(19) United States
(12) Patent Application Publication
(10) Pub. No.: US 2017/0057175 A1
(43) Pub. Date: Mar. 2, 2017

(54) SYSTEM AND METHOD FOR FIVE-DIMENSIONAL ADDITIVE MANUFACTURING

(71) Applicant: MAYO FOUNDATION FOR MEDICAL EDUCATION AND RESEARCH, Rochester, MN (US)

(72) Inventors: Shanda Blackmon, Rochester, MN (US); Jane M. Matsumoto, Rochester, MN (US)

(21) Appl. No.: 15/256,046

(22) Filed: Sep. 2, 2016

Related U.S. Application Data
(60) Provisional application No. 62/213,610, filed on Sep. 2, 2015.

(51) Int. Cl. B29C 67/00

(52) U.S. Cl. CPC B29C 67/0088; B33Y 10/00

(57) ABSTRACT

Systems and methods are provided for five-dimensional additive manufacturing. The method may include acquiring medical imaging data of a patient that includes anatomical and physiological data. The medical imaging data may be segmented based on the anatomical data and the physiological data and may be converted into a virtual three-dimensional model. The virtual three-dimensional model may be translated into control instructions for an additive manufacturing system to create a physical model of the patient. The physical model can vary in five dimensions: height, width, depth, change in pathology size, and physiology.

### CROSS-REFERENCE TO RELATED APPLICATIONS

This application is based on, claims priority to, and incorporates herein by reference in its entirety, U.S. Provisional Application Ser. No. 62/213,610, filed Sep. 2, 2015, and entitled “Five Dimensional Printing.”

### BACKGROUND

The present disclosure relates generally to additive manufacturing, and more specifically to systems and methods of five-dimensional additive manufacturing in medical applications.

In 1982, Hideo Kodama from the Nagoya Municipal Industrial Research Institute provided the first description of three-dimensional additive manufacturing. Ten years later, the first three-dimensional additive manufacturing system was created and has been used in many settings. The surgical application of this technology is in its infancy. A three-dimensional model can convey key anatomical relationships in a way that digital images cannot and has been used to develop a scaffold for biological grafts. The three-dimensional model is particularly useful in patients who have had a complex anatomy or pathology.

Surgery can be complex and challenging, both in terms of the local anatomy and pathology, especially when previous operative intervention has been performed. Gaining a greater appreciation of the challenges faced pre-operatively, as well as mapping the patient's post-treatment condition is essential in achieving a good outcome and gaining research for subsequent similar cases. Thus, two-dimensional images and virtual three-dimensional representations communicated on electronic displays remain the gold standard for surgical planning. This is because such computer generated images or virtual models can be manipulated and displayed in a variety of different ways to provide a great deal of adjustable or selectable information. Despite providing tactile information that a virtual model cannot provide, three-dimensional models produced through additive manufacturing are still not preferred because the ability to communicate sufficient information about the patient is limited by the medium.

It would, therefore, be desirable to have additional systems and methods for facilitating clinical analysis and planning, such as surgical planning.

### SUMMARY

In accordance with one aspect of the present disclosure, a method of five-dimensional additive manufacturing is provided. The method includes acquiring medical imaging data of a patient including anatomical data and physiological data and segmenting the medical imaging data using the anatomical data and physiological data. The method also includes converting the segmented medical imaging data into a virtual three-dimensional model and translating the virtual three-dimensional model into control instructions for an additive manufacturing system to create a physical model of the patient. The physical model varies in five dimensions, the five dimensions are height, width, depth, change in pathology size, and physiology.

In accordance with another aspect of the present disclosure, a system for five-dimensional additive manufacturing is provided. The system includes a non-transitive memory having stored therein medical imaging data of a patient including anatomical data and physiological data and a processor configured to access the memory and execute medical imaging data. The processor is caused to segment the medical imaging data using the anatomical data and physiological data and convert the segmented medical imaging data into a virtual three-dimensional model. The processor is also caused to translate the virtual three-dimensional model into control instructions for an additive manufacturing system to create a physical model of the patient, wherein the physical model varies in five dimensions, the five dimensions are height, width, depth, change in pathology size, and physiology. The system also includes a communication port configured to communicate the virtual three-dimensional model to the additive manufacturing system.

### BRIEF DESCRIPTION OF THE DRAWINGS

FIG. 1 is a schematic illustration of an additive manufacturing system configured to implement a manufacturing process according to one aspect of the present disclosure.

FIG. 2 is a schematic illustration of an exemplary system for five-dimensional additive manufacturing.

FIG. 3 is a block diagram showing an exemplary method of five-dimensional additive manufacturing.

### DETAILED DESCRIPTION

While three-dimensional additive manufacturing has improved many aspects of complex surgeries, modeling in three dimensions fails to illustrate the effects a treatment may have on a pathology or how a pathology may change over time both anatomically and physiologically. Specifically, three-dimensional modeling fails to provide anatomical and physiological information relating to the patient and the pathology within the patient. Three dimensional modeling further fails to show how the pathology has changed over time or in response to a treatment. Therefore, what is needed is a system and method for five-dimensional manufacturing in medical applications. The present disclosure overcomes the aforementioned drawbacks of three-dimensional additive manufacturing, by allowing the ability to incorporate additional information, such as incorporating the patient's pre-treatment and post-treatment anatomical and physiological data. This information can be communicated through displaying the state of a pre-treatment patient and pathology and the post-treatment patient and pathology both anatomically and physiologically.

The present disclosure provides exemplary systems and methods for five-dimensional manufacturing in medical applications. The medical application of five-dimensional additive manufacturing enables tangible representation of the effectiveness of treatment, as well as all aspects that a three-dimensional model can provide. The use of three-dimensional models can address potential treatment challenges, allowing a cohesive understanding of the anatomical complexities by all members of a multidisciplinary medical team and promotes problem-solving strategies. The patient benefits from the tactile and visual information provided by the three-dimensional model while the planned procedure is being explained, enhancing his or her understanding of the anatomy and proposed surgery. The enhancement of three-dimensional additive manufacturing to five-dimensional additive manufacturing, can utilize the pre-treatment and post-treatment state of the patient to exhibit changes in a pathology and which parts of the pathology still remain active. The five-dimensional model may provide an improved appreciation of anatomical and physiological relationships, particularly in complex cases, as well as effectiveness of the provided treatment.

In some configurations, a method of five-dimensional additive manufacturing may include one or more steps. The steps may comprise a first step to acquire medical imaging data of a patient, which may include anatomical data and physiological data. A second step may segment the medical imaging data using the anatomical data and physiological data. A third step may convert the segmented medical imaging data into a virtual three-dimensional model. A fourth step may translate the virtual three-dimensional model into control instructions for an additive manufacturing system, which may create a physical model of the patient. The physical model may vary in five dimensions, the five dimensions can be height, width, depth, change in pathology size, and physiology.

Alternatively or additionally, the first step may include acquiring a first subset of data before the patient receives a treatment and a second subset of data after the patient receives the treatment. The method may further include analyzing the first subset of data and the second subset of data to identify differences therebetween. The second step may include segmenting the medical imaging data using at least one of Hounsfield units, image intensity, or metabolic activity. The fourth step may further include selecting characteristics of the physical model based on the differences identified therebetween. The characteristics of the physical model may include at least one of color, transparency, size, or flexibility. The method may further include a step of manufacturing the physical model of the virtual three-dimensional model using the additive manufacturing system. The method may further include performing at least one of a preoperative or a postoperative planning analysis using the physical model.

In some configurations, a system for five-dimensional additive manufacturing may include a non-transitive memory that may store medical imaging data of a patient. The medical imaging data of the patient may include anatomical data and physiological data. The system for five-dimensional additive manufacturing may further comprise a processor configured to execute one or more steps. The processor may segment the medical imaging data using the anatomical data and physiological data and converting the segmented medical imaging data into a virtual three-dimensional model. The processor may also translate the virtual three-dimensional model into control instructions for an additive manufacturing system to create a physical model of the patient. The physical model may vary in five dimensions, the five dimensions are height, width, depth, change in pathology size, and physiology. The system for five-dimensional manufacturing may further comprise a communication port configured to communicate the virtual three-dimensional model to the additive manufacturing system.

Additionally or alternatively, the system may segment the medical imaging data using at least one of Hounsfield units, image intensity, or metabolic activity. The medical imaging data may comprise a first subset of data before the patient receives a treatment and a second subset of data after the patient receives the treatment. The system may be configured to analyze the first subset of data and the second subset of data to identify differences therebetween, and select characteristics of the physical model based on the differences. These characteristics may include at least one of color, transparency, size, or flexibility. The physical model may be used for performing at least one of a preoperative or a postoperative planning analysis using the physical.

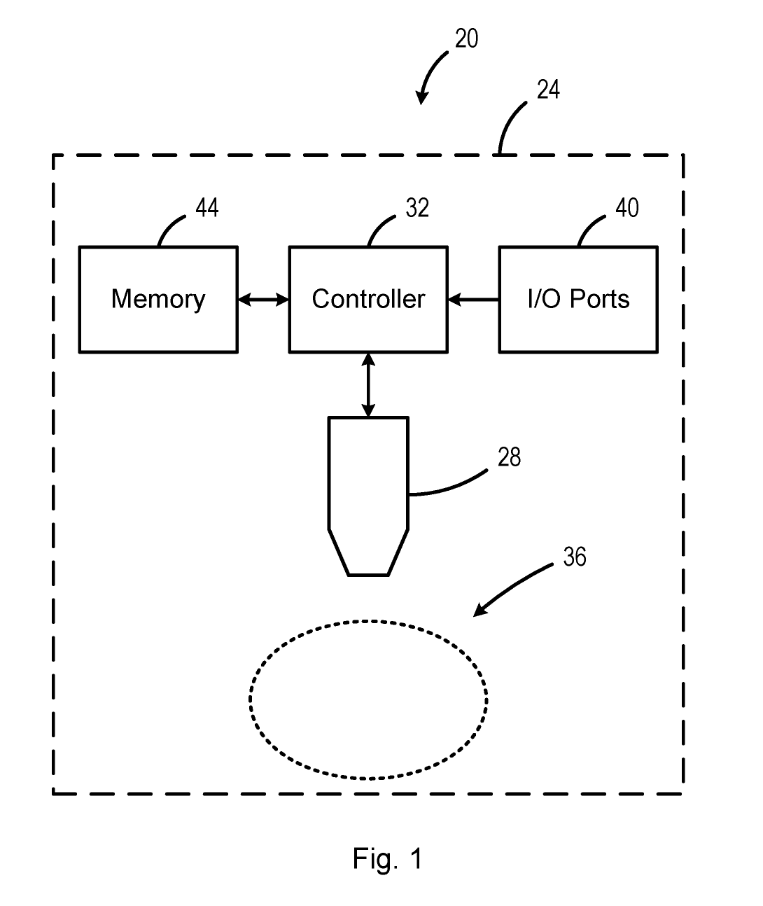

Methods of five-dimensional additive manufacturing may be implemented into a printing system to enable conformal additive manufacturing of, or onto, an object. FIG. 1 shows a non-limiting example of one such system 20 for performing additive manufacturing. The system 20 can include a printing system 24 having a print head 28 in communication with a controller 32 and configured to deposit material onto an object 36. The system 20 can support the object 36 by known mechanism, for example, by directly mounting or grasping the object 36. The specific mechanism used to secure the object 36 is not meant to be limiting in any way. Also, the illustrated shape of the object 36 is not meant to be limiting in any way as many different shapes for the object 36 are possible.

The print head 28 can be coupled to a mechanical linkage (not shown) capable of positioning the print head 28 in various locations in a three-dimensional coordinate system defined around the object 36. The positioning of the print head 28 can be controlled by the controller 32. The material deposited by the print head 28 can be a polymer, a metal, glass, sands, waxes, paper, or other materials known in the art or developed in the future. The controller 32 can be in communication with I/O ports 40 and a memory storage device 44. The memory storage device 44 can be a non-transitory memory storage device.

Alternatively or additionally, the mechanical linkage coupled to the print head 28 can take the form of a print head articulation mechanism (not shown) and the object 36 can be coupled to a build object articulation mechanism 318 (not shown). Such printing systems are known in the art of three-dimensional printing systems. The print head articulation mechanism can be instructed by the controller 32 to direct the print head 28 to a desired position and/or orientation within a range of motion of the print head articulation mechanism. Similarly, the build object articulation mechanism can be instructed by the controller 32 to direct the object 36 to a desired position and/or orientation within a range of motion of the build object articulation mechanism. In this non-limiting example, the object 36 being printed on by the print head 28 is not required to be flat as the controller 32 can reorient the print head 28 via the print head articulation mechanism and/or the object 36 via the build object articulation mechanism, as desired.

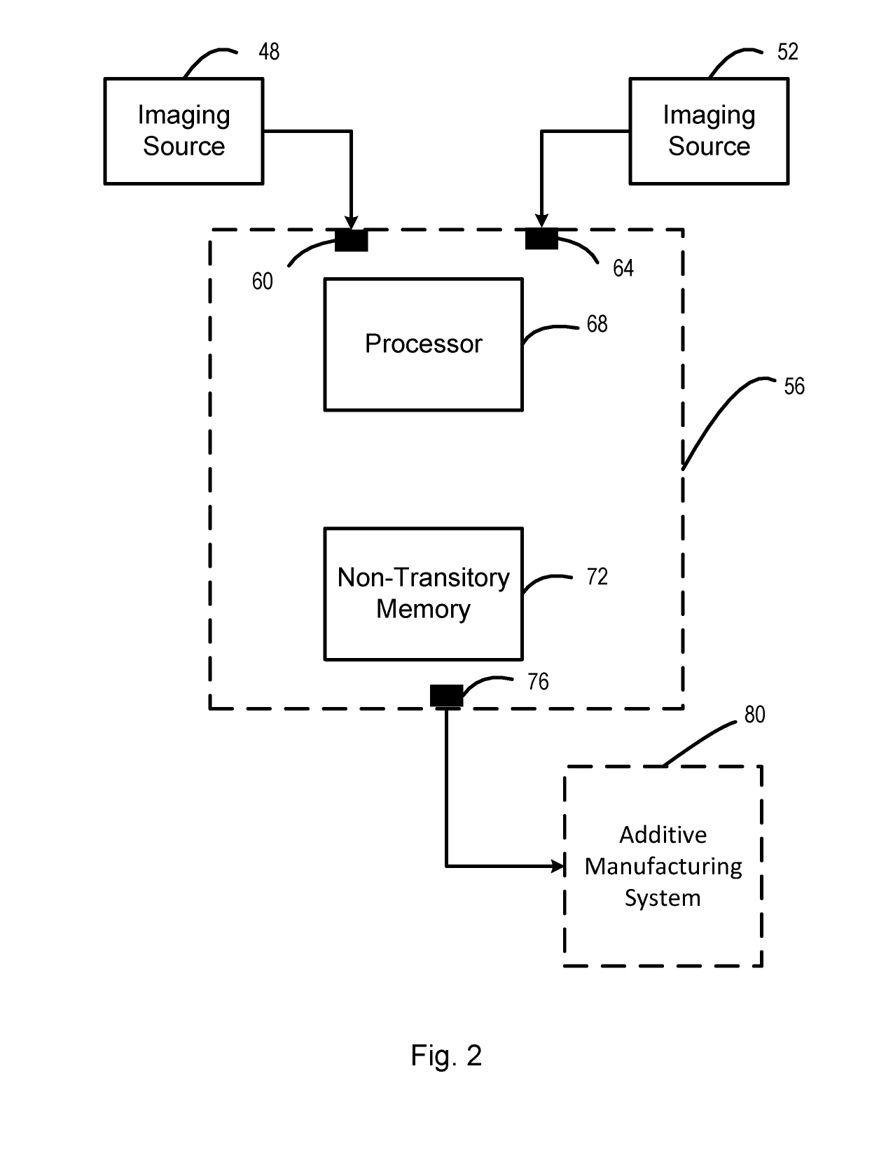

Systems of five-dimensional additive manufacturing may configured to enable conformal additive manufacturing of, or onto, an object. FIG. 2 schematically shows a non-limiting example of one such system 56 for performing five-dimensional additive manufacturing.

In one configuration, the system 56 can have one or more inputs. As shown, a first input 60 can be configured to connect to a first imaging source 48 and a second input 64 can be configured to connect to a second imaging source 52. The first imaging source 48 and the second imaging source 52 may supply medical imaging data to the system 56 via the first input 60 and the second input 64. The medical imaging data supplied to the system 56 may be stored in a non-transitory memory 72.

The first imaging source 48 and the second imaging source 52 may be medical imaging sources. Non-limiting examples of medical imaging sources for use in this application can be x-ray systems, computed tomography (CT), magnetic resonance imaging (MRI), positron emission tomography (PET), ultrasound, or other medical imaging systems or modalities. The first imaging source 48 can be any of a variety of medical imaging sources, and the second imaging source 52 can be any of a variety of medical imaging sources. Although a first imaging source 48 and a second imaging source 52 are shown, a combination of one or more imaging sources may be utilized as inputs to the system 56. A non-limiting example of a combination of imaging sources may feature a CT imaging system as the first imaging source 48 and a PET imaging system as the second imaging source 52. Additionally or alternatively, the first imaging source 48 may be a CT imaging system, the second imaging source 52 may be a PET imaging system, and an MRI imaging system may be a third imaging source.

The first imaging source 48 and the second imaging source 52 may supply medical imaging data of a patient to the system 56. The medical imaging data may comprise anatomical data and physiological data. In some embodiments, the anatomical data may be received from the first imaging source 48 and the physiological data may be received from the second imaging source 52. In other embodiments, the anatomical data may be received from the second imaging source 52 and the physiological data may be received from the first imaging source 48. In still other embodiments, the anatomical data and physiological data may be provided by a combination of imaging sources. Although a first imaging source 48 and a second imaging source 52 are shown, a combination of one or more imaging sources may be utilized as inputs to the system 56.

The anatomical data acquired from one or more imaging sources may comprise one or more three-dimensional structures of a patient. The one or more three-dimensional structures of a patient may comprise a combination of anatomical features of the patient. A non-limiting example of anatomical features that may be within the anatomical data include the aorta, pulmonary arteries and veins, superior vena cava, upper ribs, sternum, spine, brachial plexus, and upper thoracic nerve roots. The anatomical features of the patient may include one or more pathologies that may be of interest in a treatment of the patient. A non-limiting example of a pathology may be a tumor or cancerous growth within or attached to one or more anatomical features of the patient.

The physiological data acquired from one or more imaging sources more comprise one or more physiological features of the patient. The one or more physiological features may comprise a combination of the patient's physiological features. The physiological features of the patient may relate one or more pathologies that may be of interest in the treatment of the patient. A non-limiting example of a physiological feature that may relate to a pathology may be abnormal metabolic activity that may be associated with a tumor or cancerous growth within or attached to one or more anatomical features of the patient.

The medical imaging data may be acquired at one or more instances in time. In a non-limiting example, the medical imaging data may be acquired at a first time and a second time. The first time may be before the patient receives a treatment and may be associated with a first subset of data, and the second time may be after the patient receives a treatment and may be associated with a second subset of data.

Although two times are described in this example, a number of instances in time of medical imaging data may be acquired and their respective data subsets may be used. In another non-limiting example, the medical imaging data may be stored in digital imaging and communication in medicine (DICOM) format.

The processor 68 may receive the medical imaging data from the non-transitory memory 72. The processor 68 may be configured to execute one or more steps to the medical imaging data. The processor 68 may co-register the medical imaging data from the one or more imaging sources. The co-registered medical imaging data may contain data including anatomical and physiological features of a pathology before and after a treatment has been given to a patient. The processor 68 may segment the co-registered medical imaging data using the anatomical and physiological data. Segmentation may be performed by the processor 68 using at least one of Hounsfield units, image intensity, or metabolic activity. In some embodiments, manual segmentation may be performed in addition to or independent of the segmentation performed by the processor 68.

The processor 68 may convert the segmented medical imaging data into a virtual three-dimensional model. The processor may create the virtual three-dimensional model that may depict the anatomical and physiological features identified in the medical imaging data. The virtual three-dimensional model may be formatted in a stereolithogrpahy (STL) file format. The processor may translate the virtual three-dimensional model into control instructions for an additive manufacturing system 80 that may create a physical model of the patient. The control instructions generated by the processor 68 can include variations in the model in five dimensions.

The five dimensions of the control instructions can be height (y axis), width (x axis), depth (z axis), change in pathology size, and physiology. The processor can analyze the first subset of data acquired before the patient receives a treatment and the second subset of data acquired after the patient receives a treatment to identity differences between the two data subsets. Differences between the first subset of data and the second subset of data may be used in selecting the physical characteristics to be applied to the physical model.

Characteristics of the physical model can be modified with at least one of color, transparency, size, or flexibility. The characteristics of the physical model can be modified to indicate differences in the anatomical structures within the physical model as well as to indicate anatomical differences between the first subset of data and the second subset of data. A non-limiting example of differences in physical characteristics may include assigning a pre-treatment pathology such as a tumor a clear material and a solid color to a pathology after treatment has been performed. The differences in physical characteristics in this example show how the pathology has changed in response to the treatment applied, specifically the shrinking of the pathology.

Additionally or alternatively, the physiological data and corresponding characteristics may be accounted for by modifying characteristics of the physical model. Such characteristics to be modified can include at least one of color, transparency, size, or flexibility. The characteristics of the physical model can be modified to indicate physiological differences in the structures within the physical model as well as to indicate physiological differences between the first subset of data and the second subset of data. A non-limiting example of changing physical characteristics may include assigning differences in metabolic activity different solid colors thereby indicating activity of a pathology or lack thereof. The differences in physical characteristics in this example show how the pathology has changed in response to the treatment applied, specifically areas of the pathology that have shown increased or decreased metabolic activity.

The processor 68 can pass the control instructions through a communication port 76 of the system 56. The communication port 76 of the system 56 may communicate the control instructions generated by the processor 68 to the additive manufacturing system 80. The additive manufacturing system 80 may be configured to generate a five-dimensional physical model. In some embodiments, the additive manufacturing system 80 may generate physical models using an exemplary system 20 shown in FIG. 1, following the control instructions provided by the processor 68 through the communication port 76.

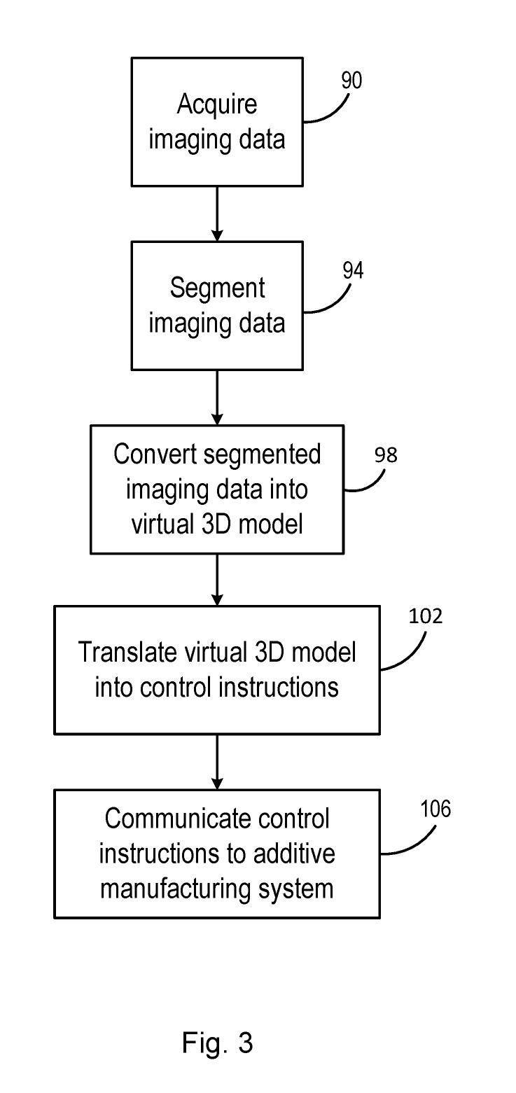

Now that the components of the system have been described in detail along with their respective functions, a method of use of the system can be understood. Referring now to FIG. 3, a block diagram of a non-limiting exemplary method of five-dimensional additive manufacturing is shown.

The method includes steps comprising a first step 90 where imaging data is acquired. The imaging data may be medical imaging data that includes anatomical data and physiological data and may be acquired in one or more subsets. In some embodiments, the one or more subsets may include a first data subset and a second data subset. The first data subset may be acquired before a patient receives a treatment;

the second data subset may be acquired after the patient receives a treatment. The one or more subsets of medical imaging data may be co-registered thereby creating a combined set of data including each of the subsets of data. In some embodiments, the co-registering of data may be selective, thereby comprising data of interest.

The medical imaging data acquired in a first step 90 may be segmented in a second step 94. The medical imaging data may be segmented using the anatomical and physiological data thereby indicating differences within the medical imaging data. Segmentation may be performed using at least one of Hounsfield units, image intensity, or metabolic activity. The second step 94 may be automated, manual, or a combination of automated and manual segmentation.

The segmented medical imaging data generated in the second step 94 may be converted into a virtual three-dimensional model in a third step 98. The virtual three-dimensional model may depict the anatomical and physiological features identified in the medical imaging data. The virtual three-dimensional model may be formatted in a stereolithogrpahy (STL) file format. The virtual three-dimensional model STL file may be compared to the segmented medical imaging data to ensure the STL file accurately depicts the segmented medical imaging data.

The virtual three-dimensional model generated in the third step 98 may be translated into control instructions in a fourth step 102. The control instructions can include variations in the model in five dimensions: height (y axis), width (x axis), depth (z axis), change in pathology size, and physiology. The five dimensions of variations included in the control instructions may be determined by analyzing the one or more data subsets. In one non-limiting example, the first subset of data before the patient receives a treatment and the second subset of data after the patient receives a treatment may be analyzed to identity differences between the two data subsets. Differences between the first subset of data and the second subset of data may be used in selecting the physical characteristics to be applied to the physical model. Characteristics of the physical model can be modified with at least one of color, transparency, size, or flexibility.

The characteristics of the physical model can be modified to indicate differences in the anatomical structures within the physical model as well as to indicate anatomical differences between the first subset of data and the second subset of data. A non-limiting example of differences in physical characteristics may include assigning a pre-treatment pathology such as a tumor a clear material and a solid color to a pathology after treatment has been performed. The differences in physical characteristics in this example show how the pathology has changed in response to the treatment applied, specifically the shrinking of the pathology.

Additionally or alternatively, the physiological data and corresponding characteristics may be accounted for by modifying characteristics of the physical model. Such characteristics to be modified can include at least one of color, transparency, size, or flexibility. The characteristics of the physical model can be modified to indicate physiological differences in the structures within the physical model as well as to indicate physiological differences between the first subset of data and the second subset of data. A non-limiting example of changing physical characteristics may include assigning differences in metabolic activity different solid colors thereby indicating activity of a pathology or lack thereof. The differences in physical characteristics in this example show how the pathology has changed in response to the treatment applied, specifically areas of the pathology that have shown increased or decreased metabolic activity.

The variations in characteristics included in the control instructions may be communicated to an additive manufacturing system in a fifth step 106. The additive manufacturing system may create a physical model of the patient. The additive manufacturing system may manufacture the physical model using liquid photopolymers which may be surrounded by a support material which may allow for the model to hold its shape while the material hardens. In a non-limiting example, the material may be hardened using ultraviolet light. The support material may be removed from the physical model once the material has fully hardened using pressurized liquid or other removal techniques. In some embodiments, a pathology may be manufactured separately from the physical model and may be assembled into the model. Alternatively, the pathology may be manufactured within the physical model.

In some configurations, the physical model generated can be used for at least one of pre-operative or post-operative analysis. Pre-operative analysis may be used to plan a treatment, while post-operative analysis may be used to assess the effectiveness of a treatment on a pathology. Non-limiting examples of treatments to be planned or assessed may include neoadjuvant therapies, surgical procedures, chemotherapy, radiation therapy, or other medical treatment techniques.

Now that the components and a method of use for the system have been described in detail, a non-limiting clinical example may be provided.

In a non-limiting example, a patient is a 39 year-old-woman presented with chest pain and was found to have a left sided superior sulcus tumor with suspicious aorto-pulmonary window lymph nodes. The patient underwent neoadjuvant chemotherapy with cisplatin and etoposide and received 60 Gy of radiation. Cancer restaging revealed excellent tumor response to the treatment but persistent involvement of the left subclavian artery, first rib, and T2-T3 nerve roots with vertebral body invasion. A cerebral angiogram confirmed widely patent innominate, carotid and vertebral arteries. Pulmonary function tests revealed adequate reserve to tolerate a lobectomy (FEV1-77% DLC0-76%).

A five-dimensional anatomic model was printed using imaging data from the patient's CT, MRI and PET scans. From these data, additional thin 1 mm images are reconstructed in order to minimize stair-step artifacts in 3D printing. The imaging data, stored in Digital Imaging and Communication in Medicine (DICOM) format, is transferred into a processor. Five-dimensional anatomic models incorporate pre-treatment and post-treatment CT scans to create a combined image displaying the tumor prior to treatment, and the post-treatment tumor within the original. PET scans are stored in DICOM format as well, and co-registered with the CT images. The imaging data is then segmented using Hounsfield units, image intensity, and based on metabolic activity from PET, as well as hand segmented to provide greater accuracy of the critical structures involved. The segmented data is converted into a virtual 3D anatomic model, which is then exported into an STL (stereolithography) file format. The final STL file is reimported into the source imaging data to ensure that its outline accurately matched what was initially segmented.

The STL files are communicated to an additive manufacturing system for printing. Different colors were assigned to the various anatomic structures and several materials, both rigid and flexible, were selected. To enhance the mechanism and make it five-dimensional, the original tumor assigned a clear material and the post-treatment tumor was assigned a solid color, so to allow visible representation of the tumor shrinking. The FDG uptake within the tumor was assigned a different solid color to show which parts of the remaining tumor were still active. Life size models are then printed using liquid photopolymers on the 3D printer. The material is printed with surrounding support material which is washed off after the model is created. These physical life size anatomic models can be used for multi-disciplinary pre-operative and postoperative discussions, surgical planning and as part of the patient education and consent process.

The vascular, orthopedic and thoracic teams met pre-operatively to discuss and rehearse the surgical procedure. Ultimately, patient was taken to the operating room for a staged resection. A mediastinoscopy and left video-assisted thoracoscopy to sample AP window nodes along with inferior pulmonary ligament nodes was performed. Mediastinal lymph nodes were uninvolved with tumor at the time of sampling, allowing the team to proceed with an osteotomy of left ribs one to three, rhizotomy of nerve roots of T1-T3 and hemivertebrectomy of T2-T3. Two days later, lobectomy and chest wall resection via left trapdoor incision, subclavian artery resection with subsequent left carotid to subclavian bypass, pericardial and thymic fat pad flaps to carotid-subclavian bypass and bronchial stump, chest wall reconstruction with mesh, medial pectoralis advancement flap was performed. Final pathology revealed invasive adenocarcinoma with <10% remaining viable tumor for final pathologic stage T1aN0.

Postoperative course was significant for pneumonia which required antibiotic therapy. Patient participated actively in her recovery and strengthened daily. She ultimately was discharged home on postoperative day twenty in stable condition.

At four month follow-up patient was feeling strong and had recovered well from her surgery. Physical examination revealed good range of motion in both of her arms, with equal strength and sensation throughout. She did have mild Horner's on the left. CT scan performed at that time demonstrated no evidence of recurrence. No additional chemotherapy was recommended.

The present invention has been described in terms of one or more preferred embodiments and examples, and it should be appreciated that many equivalents, alternatives, variations, additions, and modifications, aside from those expressly stated, and apart from combining the different features of the foregoing versions in varying ways, can be made and are within the scope of the invention.

We claim:

1. A method of five-dimensional additive manufacturing, the method including steps comprising:
a. acquiring medical imaging data of a patient including anatomical data and physiological data;
b. segmenting the medical imaging data using the anatomical data and physiological data;
c. converting the segmented medical imaging data into a virtual three-dimensional model; and
d. translating the virtual three-dimensional model into control instructions for an additive manufacturing system to create a physical model of the patient;
wherein the physical model varies in five dimensions, the five dimensions are height, width, depth, change in pathology size, and physiology.

2. The method of claim 1 wherein step (b) includes segmenting the medical imaging data using at least one of Hounsfield units, image intensity, or metabolic activity.

3. The method of claim 1 further including the step of manufacturing the physical model of the virtual three-dimensional model using the additive manufacturing system.

4. The method of claim 1 wherein step (a) includes acquiring a first subset of data before the patient receives a treatment and a second subset of data after the patient receives the treatment.

5. The method of claim 4 further comprising analyzing the first subset of data and the second subset of data to identify differences therebetween and wherein step (d) includes selecting characteristics of the physical model based on the differences.

6. The method of claim 5 wherein the characteristics of the physical model include at least one of color, transparency, size, or flexibility.

7. The method of claim 1 further comprising performing at least one of a preoperative or a postoperative planning analysis using the physical model.

8. A system for five-dimensional additive manufacturing, the system comprising:
a non-transitive memory having stored therein medical imaging data of a patient including anatomical data and physiological data;
a processor configured to access the non-transtitive memory to receive the medical imaging data and to execute steps of:
a. segmenting the medical imaging data using the anatomical data and physiological data;
b. converting the segmented medical imaging data into a virtual three-dimensional model; and
c. translating the virtual three-dimensional model into control instructions for an additive manufacturing system to create a physical model of the patient wherein the physical model varies in five dimensions, the five dimensions are height, width, depth, change in pathology size, and physiology;
a communication port configured to communicate the virtual three-dimensional model to the additive manufacturing system.

9. The system of claim 8 wherein the medical imaging data is stored in Digital Imaging and Communication in Medicine format.

10. The system of claim 8 wherein step (a) includes segmenting the medical imaging data using at least one of Hounsfield units, image intensity, or metabolic activity.

11. The system of claim 8 wherein the medical imaging data comprises a first subset of data before the patient receives a treatment and a second subset of data after the patient receives the treatment.

12. The system of claim 11 wherein the system is configured to analyze the first subset of data and the second subset of data to identify differences therebetween and wherein step (c) includes selecting characteristics of the physical model based on the differences.

13. The system of claim 12 wherein the characteristics of the physical model include at least one of color, transparency, size, or flexibility.

14. The system of claim 8 wherein the physical model is used for performing at least one of a preoperative or a postoperative planning analysis using the physical model.
